(19) United States
(12) Patent Application Publication
(10) Pub. No.: US 2025/0216012 A1
(43) Pub. Date: Jul. 3, 2025

(54) APPARATUS ALLOWING FOR ROTATIONAL MOVEMENT

(71) Applicant: Michael Chiang, Santa Fe Springs, CA (US)

(72) Inventors: Michael Chiang, Rowland Heights, CA (US); Chao-Chi Chen, Changhua (TW)

(21) Appl. No.: 18/403,614

(22) Filed: Jan. 3, 2024

(51) Int. Cl. F16L 37/12

(52) U.S. Cl. CPC F16L 37/1225

(57) ABSTRACT

A connecting apparatus provides for rotational movement while maintaining a secured connection. The connecting apparatus has a connector. The connector comprises a connector body and one or more rotation ends coupled to the connector body. A rotation fitting is located at least partially inside the connector though each rotation end, and the rotation fitting defines a rotation fitting groove. A rotation clip engages and secures the rotation fitting to the connector by extending inside each rotation end and engaging the rotation fitting groove. The rotating fitting can rotate in relation to the connector.

### BACKGROUND

In some environments, there is movement of fluid lines while connected to fixed items. This movement can lead to failure and fatigue of the connecting apparatus, piping and/or tubing.

### BRIEF DESCRIPTION OF THE DRAWINGS

Implementations of the present technology will now be described, by way of example only, with reference to the attached figures, wherein:

FIG. 1 shows an embodiment of a connecting apparatus.

FIG. 2 shows a partial cross-section of an embedment of a connecting apparatus.

FIG. 3 shows an exploded view of an embodiment of a connecting apparatus.

FIG. 4 shows an exploded view of the embodiment of FIG. 3 from another angle.

FIG. 5 shows the insertion of an embodiment of the rotation clip into an embodiment of the rotation end in cross-section.

FIG. 6 shows an embodiment of the connector, a cross-section of an embodiment of the rotation end, and an embodiment of a rotation clip.

FIG. 7 shows the embodiments of FIG. 6 from a different view.

FIG. 8 shows an embodiment of the connector, a cross-section of an embodiment of the pre-positioning end, and an embodiment of a pre-positioning clip.

FIG. 9 shows the embodiments of FIG. 9 from a different view.

FIG. 10 shows an embodiment of the connecting apparatus.

FIG. 11 shows an embodiment of the connecting apparatus.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. The drawings are not necessarily to scale and the proportions of certain parts may be exaggerated to better illustrate details and features. The description is not to be considered as limiting the scope of the embodiments described herein. It should be noted that references to “an” or “one” embodiment in this disclosure are not necessarily to the same embodiment, and such references mean at least one.

Several definitions that apply throughout this disclosure will now be presented.

The term “coupled” is defined as connected, whether integral with, directly attached, or indirectly attached through intervening components, and is not necessarily limited to physical connections. The connection can be such that the objects are permanently connected or releasably connected. The term “outside” refers to a region that is beyond the outermost confines of a physical object. The term “inside” indicates that at least a portion of a region is partially contained within a boundary formed by the object. The term “substantially” is defined to be essentially conforming to the particular dimension, shape or other word that substantially modifies, such that the component need not be exact. For example, substantially cylindrical means that the object resembles a cylinder, but can have one or more deviations from a true cylinder. The term “about” in relation to quantitative measurements (unless otherwise stated) includes, but is not limited to, the disclosed measure and measurements about the disclosed measure in terms of its disclosed degree. For example, “about 90” would at least include 80-100, whereas “about 90.0” would at least include 89.0-91.0. The term “comprising” means “including, but not necessarily limited to”; it specifically indicates open-ended inclusion or membership in a so-described combination, group, series, and the like.

The present disclosure is described in relation to connecting apparatus 1000 comprising a single rotation end 110 and the pre-positioning end 120, but it is to be understood that a connecting apparatus 1000 with numerous rotation ends 110 and pre-positionings 120 is also contemplated.

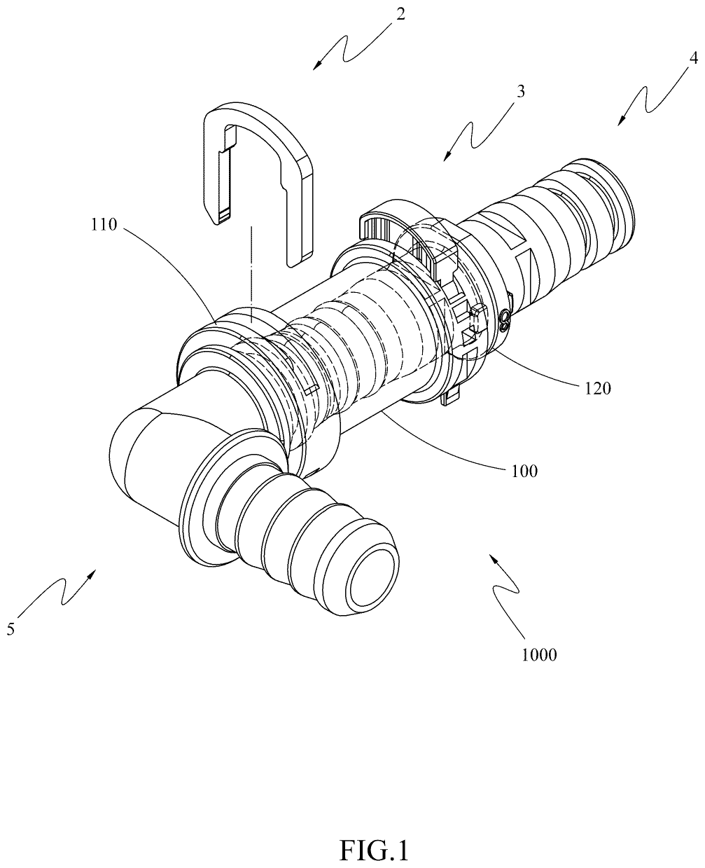

FIG. 1 illustrates an embodiment of connecting apparatus 1000. In some embodiments, the connecting apparatus 1000 comprises a connector 100, a fixed fitting 4, and a rotation fitting 5. In some embodiments, the connector 100 comprises a connector body 130, a rotation end 110, and a pre-positioning end 120. In some embodiments, the fixed fitting 4 is coupled to the connector 100 by a pre-positioning clip 3. The fixed fitting 4 is coupled to the pre-positioning end 120 by the pre-positioning clip 3 to secure the fixed fitting 4 linearly and rotationally within the connector 100. In some embodiments, the rotation fitting 5 is secured by the rotation end 110 and the rotation clip 2 such that the rotation fitting 5 is secured linearly but allowed to rotate within the connector 100.

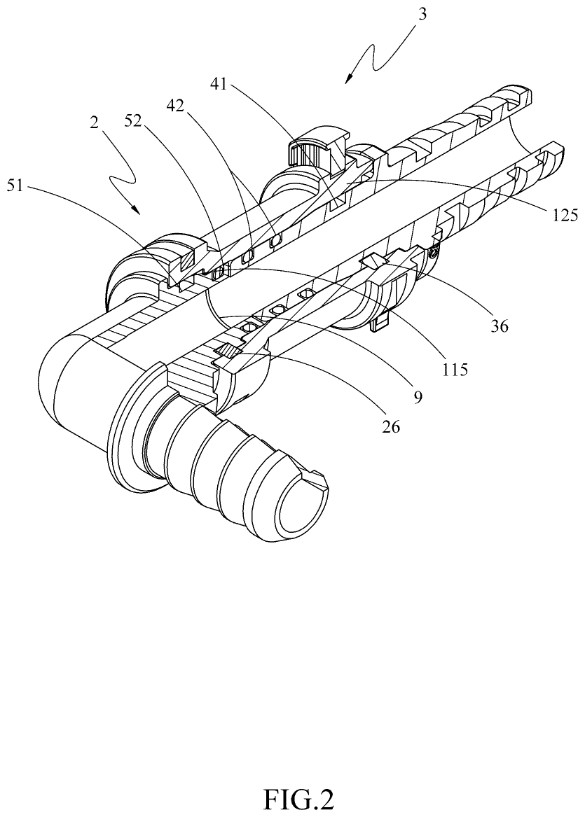

FIG. 2 illustrates a partial sectional view of an embodiment of the connecting apparatus 1000. In some embodiments, the fixed fitting seals 42 and/or the rotation fitting seals 52 abut the interior of the connector 100. In some embodiments, the rotation fitting seals 52 are configured to rotate about the inside of the connector 100 and/or the outside of the rotation fitting 5. In some embodiments, the fixed fitting 4 and the rotation fitting 5 abut each other at the interface 9 such that fluid primarily flows between the two fittings. In some embodiments, there is space between the two fittings.

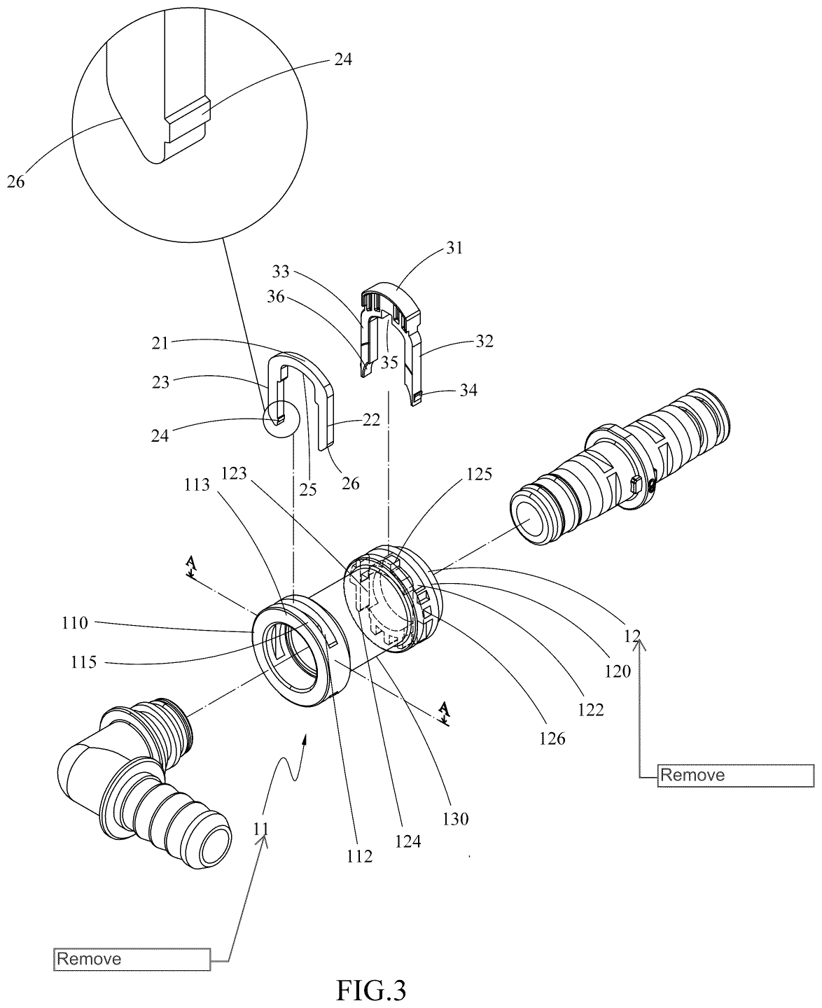

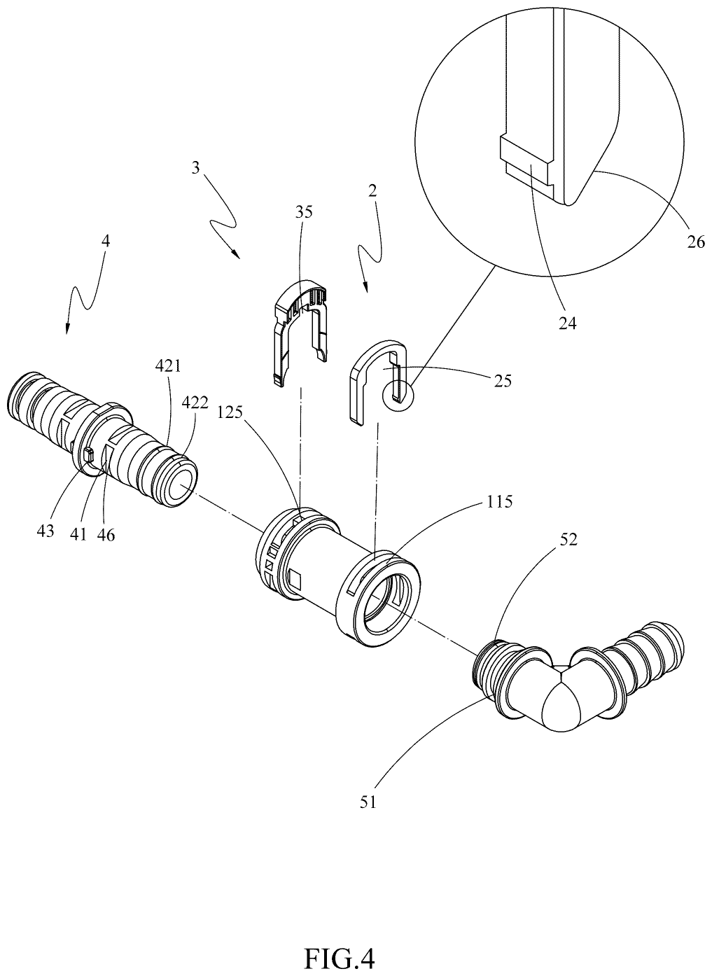

FIGS. 3 and 4 illustrate an exploded view of embodiments of the connector 100, the rotation clip 2, the pre-positioning clip 3, the fixed fitting 4, and the rotation fitting 5.

In some embodiments, the rotation end 110 defines a rotation end first entry 112, which accepts the rotation clip first arm 22, and a second rotation end entry 113, which accepts the second arm 23. In some embodiments, the rotation clip first arm 22 and the rotation clip second arm 23 can be accepted in the rotation end first entry 112 or the second rotation end entry 113. In some embodiments, when the rotation clip 2 and the rotation fitting 5 are inserted into the connector 100, the rotation clip first arm 22 and/or the rotation clip second arm 23 are engaged the rotation fitting groove 51. In some embodiments, the rotation fitting groove 51 is defined by the rotation fitting 5, and in some embodiments, it extends at least partially around, if not entirely around, the rotation fitting 5. The rotation clip first arm 22 and/or the rotation clip second arm 23 fits within the rotation fitting groove 51 and prevents linear movement of the rotation fitting 5 in relation to the connector 100. In some embodiments, the rotation fitting groove 51 may have one or more obstacles (not shown) located therein that would prevent full rotation of the rotating fitting. In some embodiments, one obstacle will abut the rotation clip 2 upon a predetermined rotation angle.

In some embodiments, the rotation end 110 comprises a rotation clip projection member 115. In some embodiments, the rotation clip projection member 115 is sized and/or shaped so it can be partially or fully inserted inside the rotation clip projection space 25. In some embodiments, the rotation clip projection member 115 will abut the rotation clip 2 when the rotation clip 2 is fully instead into the rotation end 110. In some embodiments, the rotation clip projection member 115 is sized and/or shaped to prevent the pre-positioning clip 3 from being fully inserted into rotation end 110.

In some embodiments, at least one of the rotation clip arms (22, 23) comprises a rotation clip arm projection 24. In some embodiments, each rotation clip arm projection 24 extends inwards and engages the rotation end ledge 114. In some embodiments, the interaction between each rotation clip arm projection 24 and the rotation end ledge 114 helps secure the rotation clip 2 within the rotation end 110. In some embodiments, the rotation clip 2 defines a rotation clip base 21, and the rotation clip first arm 22 and/or the rotation clip second arm 23 extend from the rotation clip base 21. In some embodiments, the rotation clip first arm 22 and the rotation clip second arm 23 are parallel to each other. In some embodiments, the rotation clip 2 is symmetrical about a plane defined by the rotation clip 2 and/or symmetrical about a perpendicular to the plane. In some embodiments, at least one of the rotation clip arms (22, 23) defines a rotation clip arm slope 26.

In some embodiments, the pre-positioning clip 3 comprises a pre-positioning clip base 31 coupled to a pre-positioning clip first arm 32 and a pre-positioning clip second arm 33. At least one or all, of the pre-positioning clip first arm 32 and the pre-positioning clip second arm 33 comprise an engagement 34 extending outward therefrom. The pre-positioning clip 3 defines a pre-positioning projection space 35. In some embodiments, the pre-positioning projection space 35 is configured to accept, at least partially, the pre-position end projection 125 inside therein. In some embodiments, the size and/or shape of the pre-positioning projection space 35 is configured to prevent the pre-positioning clip 3 from being fully inserted into the pre-positioning end 120. In some embodiments, at least one, or both, of the pre-positioning clip first arm 32 and the pre-positioning clip second arm 33 define an incline 36.

In some embodiments, the structure of the rotation end 110, rotation clip projection member 115, the rotation clip 2, the rotation clip projection space 25, the pre-positioning clip 3, the pre-positioning projection space 35, the pre-positioning end 120, and/or pre-position end projection 125 are such that the rotation clip 2 and the pre-positioning clip 3 cannot be inserted incorrectly. In some embodiments, varying widths, thicknesses, distance between arms, and/or distance between the entries can be employed.

In some embodiments, the pre-positioning clip first arm 32 and the pre-positioning clip second arm 33 are parallel. In some embodiments, the pre-positioning clip 3 is symmetrical about a plane defined by pre-positioning clip 3 and/or symmetrical about a perpendicular to the plane.

In some embodiments, the pre-positioning end 120 defines a pre-positioning end first entry 122 and a pre-positioning end second entry 123. In some embodiments, each pre-positioning end entry (122, 123) has a pre-positioning end exit 124. In some embodiments, the pre-positioning end 120 defines one or more side holes 126. Each side hole 126 communicates with either the pre-positioning end first entry 122 or the pre-positioning end second entry 123. In some embodiments, each side hole 126 allows one engagement 34 to be inserted inside. This allows a user to pre-position the pre-positioning clip 3 partially inside the pre-positioning end 120, so that the user can pre-position the pre-positioning clip 3, insert the fixed fitting 4 into the connector 100, and then fully insert the pre-positioning clip 3. In some embodiments, when the pre-positioning clip 3 is fully inserted into the pre-positioning end 120, one engagement 34 will engage an engagement ledge 127, thus requiring more force to remove the pre-positioning clip 3.

In some embodiments, the fixed fitting 4 comprises a fixed fitting positioning element 43, and the pre-positioning end 120 defines a positioning hole (not shown) in which the fixed fitting positioning element 43 can fit at least partially inside. The use of the fixed fitting positioning element 43 and the positioning hole allows for the alignment of one of the fixed fitting grooves 41, one of the pre-positioning entries (122, 123), and one of the pre-positioning clip arms (32, 33), to secure the fixed fitting 4 to the connector 100. In some embodiments, the fixed fitting 4 can be inserted into the pre-positioning end 120 in two or more orientations, and these orientations will be determined by the fixed fitting positioning element 43, the positioning holes, the fixed fitting groove 41, and or one or more fixed fitting groove obstructions 46. In some embodiments, two fixed-fitting groove obstructions 46 resulting in two fixed-fitting grooves 41. In some embodiments, there are four fixed-fitting groove obstructions 46, resulting in four fixed-fitting grooves 41. In some embodiments, there are no fixed fitting groove obstructions 46, resulting in a single fixed fitting groove 41 that encircles the fixed fitting 4. Some embodiments of the fixed fitting groove 41 define a smooth fixed fitting groove 410.

In some embodiments, the fixed fitting 4 comprises one or more fixed fitting seals (421 and 422, as shown in the drawings). In some embodiments, the fixed-fitting seals comprise o-rings. Each fixed fitting seal (421, 422) is configured to abut the inside of the connector 100 when the fixed fitting 4 is inserted therein.

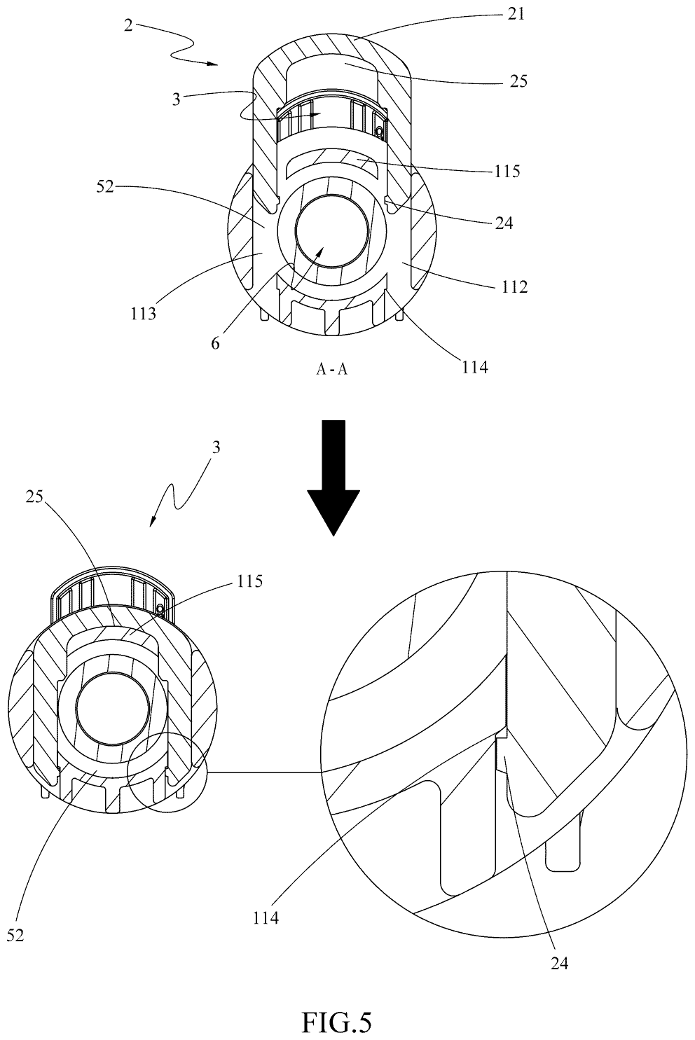

FIGS. 5-7 illustrate embodiments of the rotation end 110 and the rotation clip 2. As can be seen, in some embodiments, the process of securing the rotation fitting 5 in the connector 100 with the rotation clip 2 is shown. When the rotation fitting 5 is inserted, the rotation clip 2 is inserted into the rotation end 110. The rotation clip first and second arms (22, 23) are inserted into the rotation end first entry 112 and the second rotation end entry 113 until the rotation clip projection member 115 is located, at least partially, inside the rotation clip projection space 25. In some embodiments, one or more rotation clip arm projections 24 slide into engagement 34 with the rotation end ledge 114. In some embodiments, at least one of the rotation clip first and second arms (22, 23) can flex outwardly when being inserted and flex back so that the one or more rotation clip arm projections 24 snap back to engage inside the rotation end ledge 114. In some embodiments, the rotation clip first and second arms (22, 23) are biased towards each other. The rotation clip first and second arms (22, 23) will engage the walls of the rotation fitting groove 51. Even with the rotation, the internal passageway 6 is not substantially disturbed.

In some embodiments, nothing prevents the rotation of the rotation fitting 5. The rotation fitting groove 51 inside is smooth, as are the portions of rotation clip 2 that make contact with the rotation fitting groove 51. In some embodiments, there may be one or more obstacles in the rotation fitting groove 51 such that at a certain amount of rotation, an obstacle would abut the rotation clip 2, and in some embodiments, would abut one of the first and second rotation clip arms (22, 23), limiting the ability to rotate.

In some embodiments, the rotation clip 2 is configured to, once fully inserted into the rotation end 110, is located inside the rotation end 110. In some embodiments, the rotation clip base 21 is flush with the rotation end 110 when fully inserted. In some embodiments, the rotation clip arms (22, 23) are inside and/or flush with the rotation end 110 when the rotation clip 2 is fully inserted. In these embodiments, the interaction between the rotation clip 2 and the rotation end 110 makes removing the rotation clip 2 more challenging. This results in less accidental removal of the rotation clip 2 from the connector 100.

In some embodiments, the pre-positioning clip 3 is configured to, once fully inserted into the pre-positioning end 120, have the pre-positioning clip base 31 at least partially outside the pre-positioning end 120.

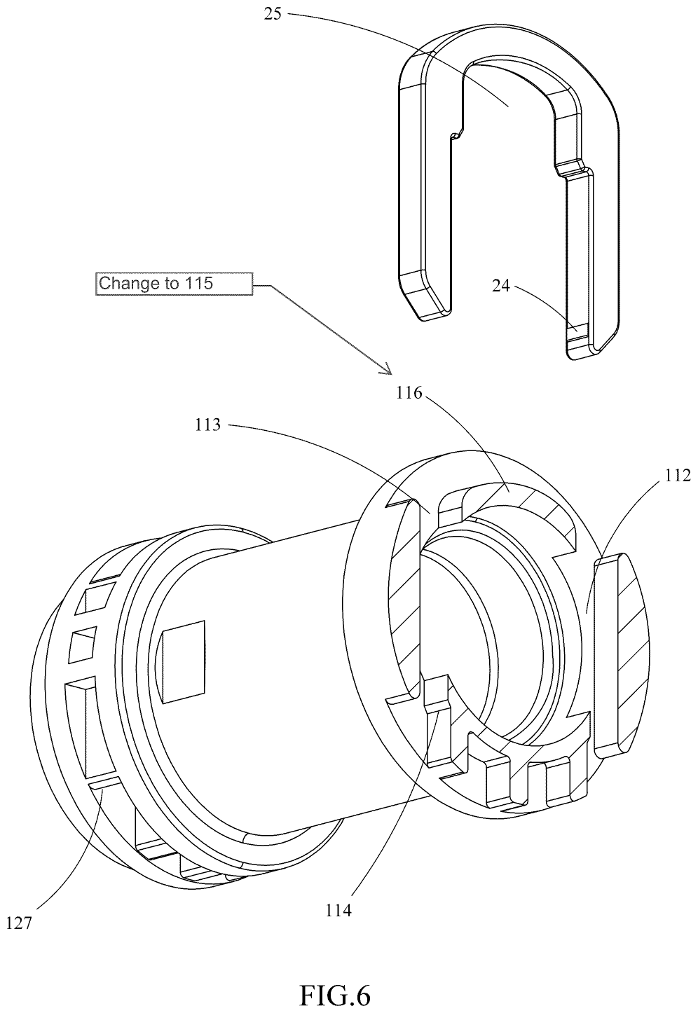

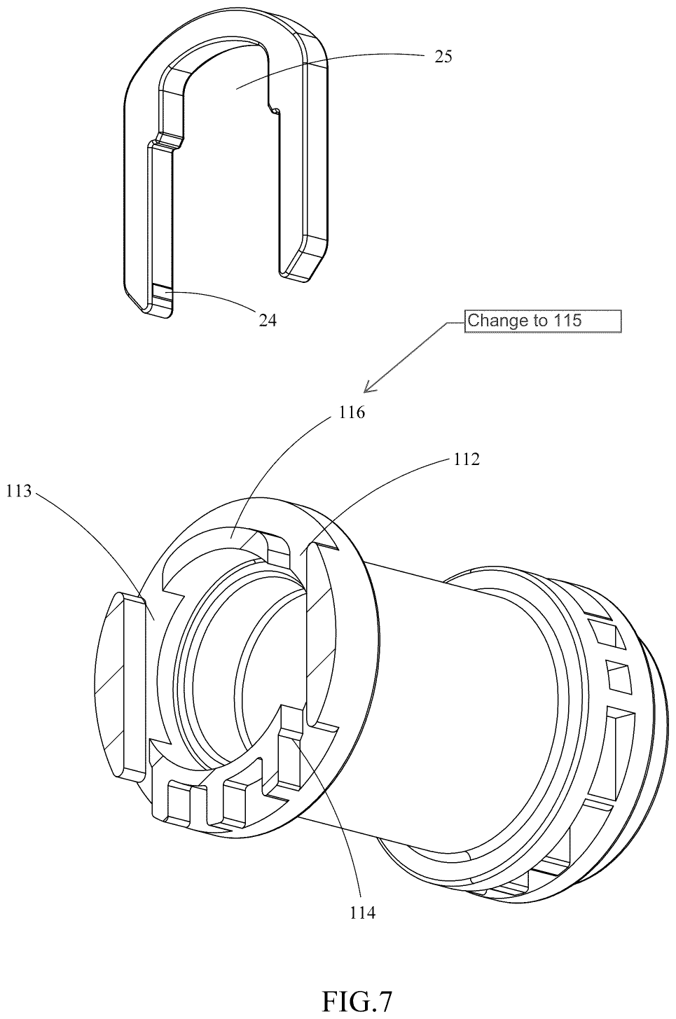

As can be seen in FIG. 6 and FIG. 7, which show opposite angles of an embodiment of the connector 100 and the rotation clip 2, how the rotation end 110 accepts the rotation clip 2. The rotation clip first arm 22 is inserted into the rotation end first entry 112, and the rotation clip second arm 23 is inserted into the second rotation end entry 113. Once inserted, the rotation clip arm projection 24 will slide over and then engage the rotation end ledge 114. In some embodiments, the rotation clip arm projection 24 defines an angled surface to allow the rotation clip arm projection 24 to slide over the rotation end ledge 114. It defines a side that substantially corresponds with the rotation end ledge 114 such that the surface abuts the rotation end ledge 114 when the rotation clip 2 is fully inserted. In some embodiments, the rotation clip 2 can be inserted in either direction into the rotation end 110.

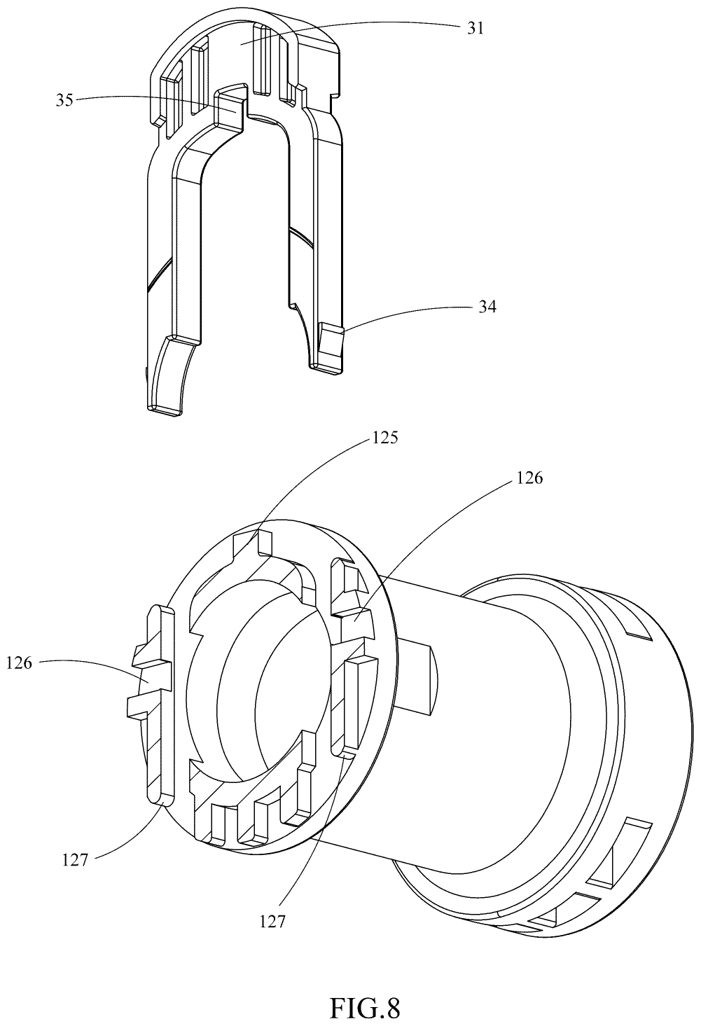

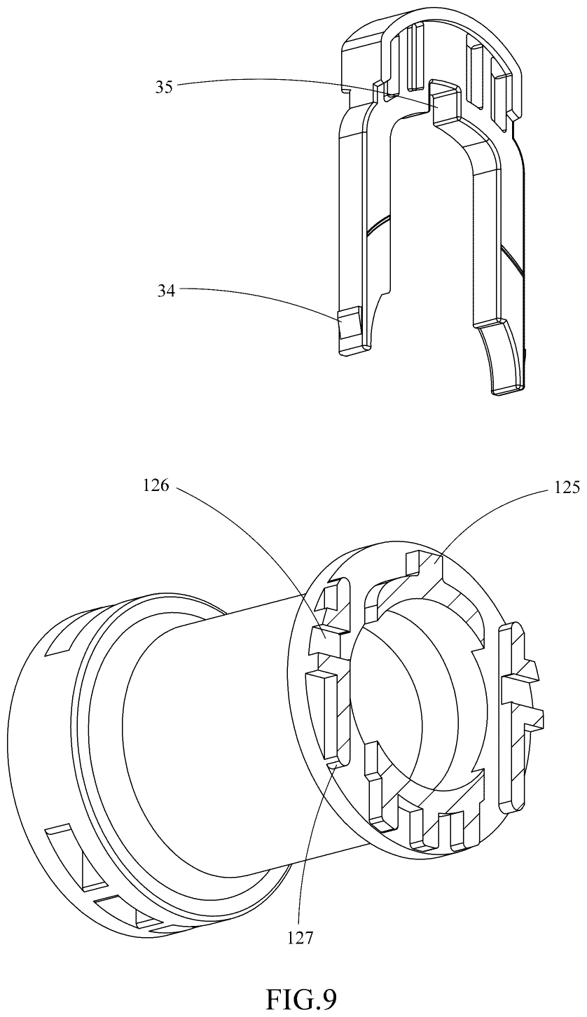

FIGS. 8 and 9, show an embodiment of the pre-positioning clip 3 and the pre-positioning end 120. As can be seen, the pre-positioning clip 3 can be inserted into the pre-positioning end 120. As the pre-positioning clip 3 is inserted, the pre-positioning clip first arm 32 and the pre-positioning clip second arm 33 enter the pre-positioning end first entry 122 and the pre-positioning end second entry 123 and the pre-positioning end second entry 123. During insertion, the one or more engagements 34 will slide along until the side hole 126 is encountered. Once the side hole 126 encounters the engagement 34, the pre-positioning clip 3 will be secured, and the fixed fitting 4 can be inserted into the pre-positioning end 120. This allows the user to pre-position the pre-positioning clip 3, before inserting the fixed fitting 4. Once the fixed fitting 4 is correctly inserted into the pre-positioning end 120, the user will just put the pre-positioning clip 3 further into the pre-positioning end 120 until the engagement 34 moves past and then into engagement 34 with the engagement ledge 127. The pre-position end projection 125 is sized and shaped to allow the pre-positioning clip 3 to be inserted into the pre-positioning end 120 while preventing the rotation clip 2 from being fully inserted.

It must be understood that while installing either clip into the connector 100 may seem simple enough when in an open environment, the connector 100 is often used and/or assembled in difficult-to-reach areas. Often, users have limited dexterity and/or sight due to the location of the connector 100. Thus, having the pre-position end projection 125, the rotation clip projection member 115, the rotation clip projection space 25, and the pre-positioning projection space 35 will help prevent a user from trying to use the improper clip on the improper fitting. Further, in some embodiments, the fixed fitting positioning element 43 prevents a user from trying to put a wrong fitting into the wrong end. It is also to be understood that in some embodiments, the size and shape of the connectors prevent proper insertion and/or alignment of the fixed fitting groove 41 and the pre-positioning end entries (122, 123). It is also to be understood that in some embodiments, the thickness of the rotation clip arms 22 and/or the pre-positioning clip arms 32 and/or the rotation end 110 and the pre-positioning end 120 entries are set to prevent a user from putting either the rotation clip 2 or the pre-positioning clip 3 in the wrong end of the connector 100.

In some embodiments, the pre-positioning clip 3 can be partially inserted into the pre-positioning end 120 so that at least one engagement 34 engages the side holes 126. By engaging the side holes 126, the pre-positioning clip 3 is secured in its partially inserted position. One of the fittings can be inserted into the connector 100, and then the pre-positioning clip 3 can be fully inserted and the fitting secured.

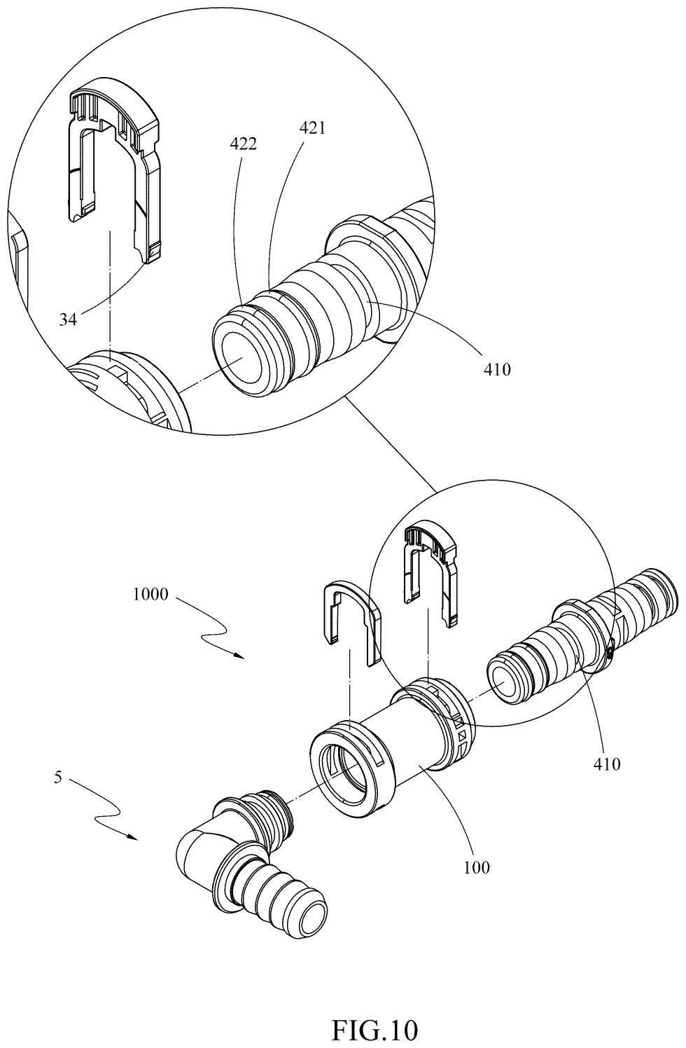

FIG. 10 illustrates an embodiment of a connecting apparatus 1000. While the rotation fitting 5 is shown with a bend, it is to be understood that the rotation fitting 5 can be straight. The same is to be said for the connector 100. In some embodiments, the connector 100 will be substantially T-shaped, with multiple ends on the same or different planes.

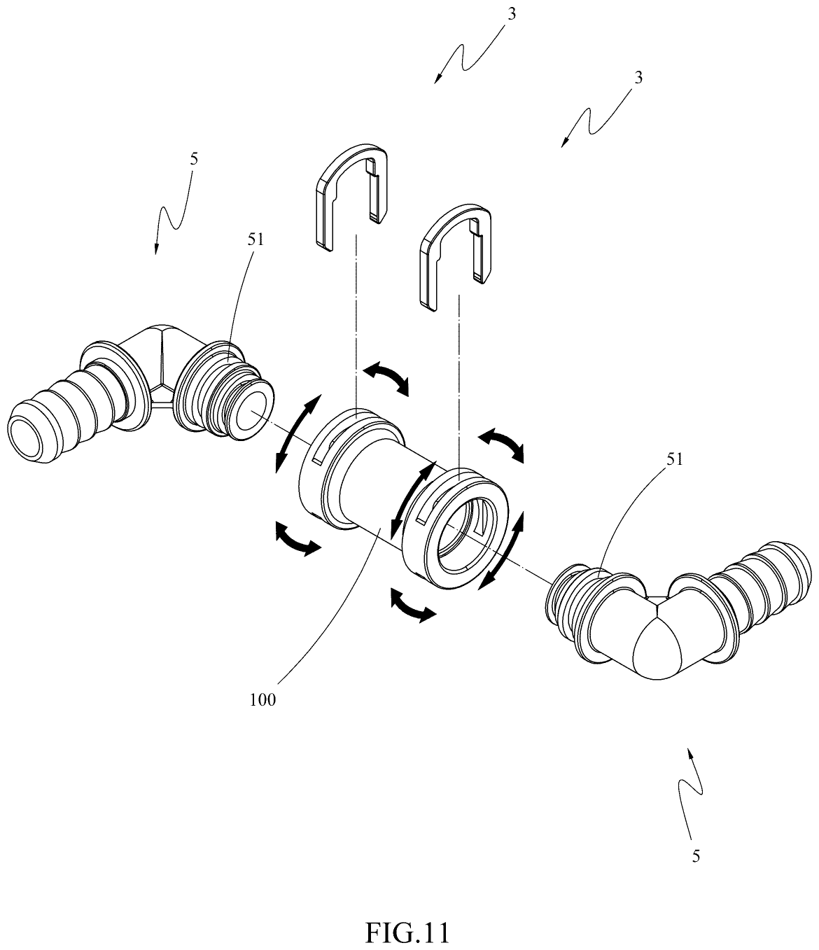

FIG. 11 shows an embodiment of a connector 100 wherein the connector 100 comprises two rotation ends 110. In some embodiments, the connector 100 is coupled to a fixed object. In some embodiments, the connector 100 is stationary. It is to be understood that a connector 100 may have two or more ends. In some embodiments, there are more pre-positioning ends 120 than rotation ends 110 or vice versa.

In some embodiments, the rotation fitting 5 comprises one or more rotation fitting seals 52. In some embodiments, there are two or more rotation-fitting seals 52. The rotation fitting seals 52 are configured to abut the interior walls of the connector 100 and create a seal therebetween. In some embodiments, one or more of the rotation fitting seals 52 are O-rings. In some embodiments, the fixed fitting 4 comprises one or more fixed fitting seals 42. In some embodiments, one or more of the fixed fitting seals 42 is an O-ring. The fixed fitting seals 42 are configured to abut against the interior walls of the connector 100 and create a seal.

In some embodiments, when installed in the connector 100, the fixed fitting 4 and the rotation fitting 5 abut each other. In some embodiments, when installed in the connector 100, the fixed fitting 4 and the rotation fitting 5 will be a distance from each other, and the interior of the connector 100 will be exposed to the fluid flow.

In some embodiments, a rotation fitting 5 can be inserted into a pre-positioning end 120, and the pre-positioning clip 3 can be secured in the rotation fitting groove 51 of the rotation fitting 5. This would mean that a user would be able to pre-position the pre-positioning clip 3. In some embodiments, the rotation end 110 comprises at least one side hole 126 and at least one engagement ledge 127. In some embodiments, the rotation clip 2 further comprises an engagement 34 extending out from one or more of the rotation clip arms 22 and is able to engage the side hole 126. In some embodiments, the rotation clip 2 comprises both one or more engagements 34 and one or more rotation clip arm projections 24, and the rotation end 110 comprises one or more side holes 126 and one or more rotation end ledges 114.

The embodiments shown and described above are only examples. Even though numerous characteristics and advantages of the present technology have been set forth in the foregoing description, together with details of the structure and function of the present disclosure, the disclosure is illustrative only, and changes may be made in the detail, including in matters of shape, size and arrangement of the parts within the principles of the present disclosure up to, and including, the full extent established by the broad general meaning of the terms used in the claims.

It should also be noted that elements of embodiments may be described in reference to the description of a particular embodiment; however, it is disclosed that elements of disclosed embodiments can be switched with corresponding elements of embodiments with the same name and/or number of other disclosed embodiments.

Depending on the embodiment, certain steps of methods described may be removed, others may be added, and the sequence of steps may be altered. It is also to be understood that the description and the claims drawn to a method may include some indication in reference to certain steps. However, the indication used is only to be viewed for identification purposes and not as a suggestion as to an order for the steps.

What is claimed is:

1. An apparatus comprising:
a connecting apparatus comprising:
a connector, wherein the connector comprises:
a connector body and one or more rotation ends coupled to the connector body;
a rotation fitting located at least partially inside the connector though each rotation end, wherein the rotation fitting defines a rotation fitting groove; and
a rotation clip engages and secures the rotation fitting to the connector by extending inside each rotation end and engaging the rotation fitting groove;
wherein the rotating fitting can rotate in relation to the connector.

2. The apparatus of claim 1, wherein the rotation clip comprises a rotation clip base and a rotation clip first arm extending from the rotation clip base; and the rotation clip first arm engages the rotation fitting groove.

3. The apparatus of claim 2, wherein the rotation clip base is flush with, or located inside, each rotation end.

4. The apparatus of claim 2, wherein the rotation clip base defines a rotation clip projection space, and each rotation end comprises a rotation clip projection member; the rotation clip projection member is located inside the rotation clip projection space.

5. The apparatus of claim 2, wherein the rotation clip first arm comprises a rotation clip arm projection, and each rotation end comprises a rotation end ledge; the rotation clip arm projection engages the rotation end ledge.

6. The apparatus of claim 2, wherein the rotation clip further comprises a rotation clip second arm that also engages the rotation fitting groove.

7. The apparatus of claim 6, wherein the rotation clip is symmetrical about a plane.

8. The apparatus of claim 2, wherein the connecting apparatus further comprises a pre-positioning clip, and the connector further comprises a pre-positioning end; and the pre-positioning clip extends inside the pre-positioning end.

9. The apparatus of claim 8, wherein the connecting apparatus further comprises a fixed fitting that defines a fixed fitting groove and extends through the pre-positioning end, and the pre-positioning clip comprises a pre-positioning clip base and a pre-positioning clip first arm; and the pre-positioning clip first arm engages the fixed fitting groove.

10. The apparatus of claim 9, wherein the fixed fitting comprises a fixed fitting positioning element that is located inside a pre-positioning hole that is defined by the pre-positioning end; and engagement of the fixed fitting positioning element and the pre-positioning hole helps prevent rotational movement of the fixed fitting.

11. The apparatus of claim 9, wherein the fixed fitting further comprises one or more fixed fitting groove obstructions that are located in the fixed fitting groove; and the one or more fixed fitting groove obstructions help prevent rotational movement of the fixed fitting by abutting the pre-positioning clip first arm.

12. The apparatus of claim 8, wherein the pre-positioning clip further comprises a pre-positioning clip second arm that also engages a fixed fitting groove.

13. The apparatus of claim 12, wherein the connecting apparatus further comprises a fixed fitting that defines the fixed fitting groove, the fixed fitting comprises a fixed fitting positioning element that is located inside a pre-positioning hole that is defined by the pre-positioning end; and engagement of the fixed fitting positioning element and the pre-positioning hole help prevent rotational movement of the fixed fitting.

14. The apparatus of claim 8, wherein the pre-positioning clip defines a pre-positioning projection space, and the pre-positioning end comprises a pre-positioning end projection that is located inside the pre-positioning projection space.

15. The apparatus of claim 8, wherein the rotation clip is sized and/or shaped such that the rotation clip cannot be fully inserted into the pre-positioning end; the pre-positioning clip is sized or shaped such that the pre-positioning clip cannot be fully inserted into the pre-positioning clip; or a combination thereof.

16. The apparatus of claim 8, wherein the pre-positioning clip comprises a pre-positioning clip base and at least one pre-positioning clip arm; and when the pre-positioning clip is fully inserted into the pre-positioning end, the pre-positioning clip base is exposed; at least a portion of the at least one pre-positioning clip arm is exposed; or a combination thereof.

17. The apparatus of claim 1, wherein the rotation clip comprises a pre-positioning clip; the pre-positioning clip comprises one or more pre-positioning clip arms, and each pre-positioning clip arm comprises an engagement; and each rotation end defines a side hole wherein the engagement engages the side hole when the pre-positioning clip is partially inserted into each rotation end.

18. The apparatus of claim 17, wherein when the pre-positioning clip is partially inserted into each rotation end, the rotation fitting can be inserted into the connector.
